(19) United States
(12) Patent Application Publication
(10) Pub. No.: US 2019/0251387 A1
(43) Pub. Date: Aug. 15, 2019

(54) IMAGE PROCESSING

(71) Applicant: SNELL ADVANCED MEDIA LIMITED, Newbury, Berkshire (GB)

(72) Inventor: Jonathan DIGGINS, Lovedean, Hampshire (GB)

(21) Appl. No.: 16/310,762

(22) PCT Filed: Jun. 16, 2017
(86) PCT No.: PCT/GB2017/051772

§ 371 Date: Dec. 17, 2018

(30) Foreign Application Priority Data
Jun. 17, 2016 (GB) 1610664.3

(51) Int. Cl. G06K 9/46; G06K 9/00

(52) U.S. Cl. CPC G06K 9/4676; G06K 9/00711

(57) ABSTRACT

A image processing system and method are provided for receiving an image with a set of feature points characteristic of the image and selecting each of the feature points to be a selected feature point. Moreover, a number of neighboring feature points associated with the selected feature point are identified and a first hash is created that includes information associated with a first pair of neighboring feature points, with the information associated with the first and second neighboring feature points representative of the relative location of these neighboring feature points to the selected feature point. Moreover, a second hash is created that includes information associated with, a second pair of neighboring feature points, with the information associated with these neighboring feature points representative of the relative location of these to the selected feature point.

### FIELD

The present invention relates generally to the area of image processing, and especially to the identification of content with different format versions in a database.

### BACKGROUND

It is a common image processing problem to identify rapidly a matching image in a database containing a potentially large number of content entities (programme; film; shot or the like), each comprising a potentially large number of images. Many different approaches have been tried. Some techniques have proved successful in the rapid identification of exact matches. In practical applications, however, there is often a need to identify a matching image where the candidate images have undergone processing to the extent that the match is no longer exact. For example, images may have been compressed or filtered and may have undergone luminance or colour processing. They may be in different formats or standards, possibly with different aspect ratios.

### SUMMARY

According to one aspect of the invention there is provided a method of image processing comprising receiving an image with a set of feature points characteristic of the image;

selecting each of the feature points in turn to be a selected feature point; identifying a number of neighbouring feature points associated with the selected feature point;

creating a first hash comprising information associated with a first pair of neighbouring feature points, comprising a first neighbouring feature point and a second neighbouring feature point, wherein the information associated with the first and second neighbouring feature points represents the relative location of the first and second neighbouring feature points compared to the selected feature point;

creating a second hash comprising information associated with, a second pair of neighbouring feature points, the third neighbouring feature point and the fourth neighbouring feature point, wherein the information associated with the third and fourth neighbouring feature points represents the relative location of the third and fourth neighbouring feature points compared to the selected feature point. According to another aspect of the invention there is provided a method of identifying content in an entity comprising:

receiving an entity having a pre-calculated table associated with the entity, wherein the entity comprises a plurality of entity images, wherein the pre-calculated table has a row for every hash value possible, and wherein each row is populated by entity image identifiers associated with entity images in which the hash occurs, and further wherein multiple hashes are associated with each of a series of feature points characteristic of each entity image;

comparing a series of hashes representing one or more desired images with the pre-calculated table, and further wherein multiple hashes are associated with each of a series of feature points characteristic of the one or more desired images;

generating a histogram representing the number of matches between the series of hashes and each entity image, wherein the histogram comprises a column for each entity image with at least one hash match;

scoring each entity image according to the number of matches;

identifying possible candidate entity images, at least in part, from the entity image scores.

According to a further aspect of the present invention there is provided a method of image processing. The method may comprise receiving an image with a set of feature points characteristic of the image, deriving multiple hash values characteristic of the image based on multiple combinations of data sets, wherein each data set is associated with one of the feature points from the set of feature points;

wherein each hash is formed from a plurality of data fields, each data field corresponding to a characteristic of a feature point, to facilitate matching of similar, but non-identical, images.

### BRIEF DESCRIPTION OF THE DRAWINGS

FIG. 1 shows a flow diagram illustrating how, in one embodiment, the feature points of an image can be identified.

FIG. 2 shows an image of a dice in which the feature points have already been identified.

FIG. 3 shows the feature points identified in FIG. 2, and also shows the selected feature point, and the identified neighbouring feature points.

FIG. 4 shows the determination of the relative positions between the neighbouring feature points and the selected feature point.

FIG. 5 shows the relative positions of the neighbouring feature points relative to the selected feature point on top of the original image of the dice.

FIG. 6 shows a flow diagram showing the steps required in the creation of multiple hashes characteristic of an image.

FIG. 7 shows a flow diagram showing the steps required in identifying candidate entity images that match one or more desired images.

FIG. 8 shows a possible configuration of the structure of the information in a hash.

### DETAILED DESCRIPTION

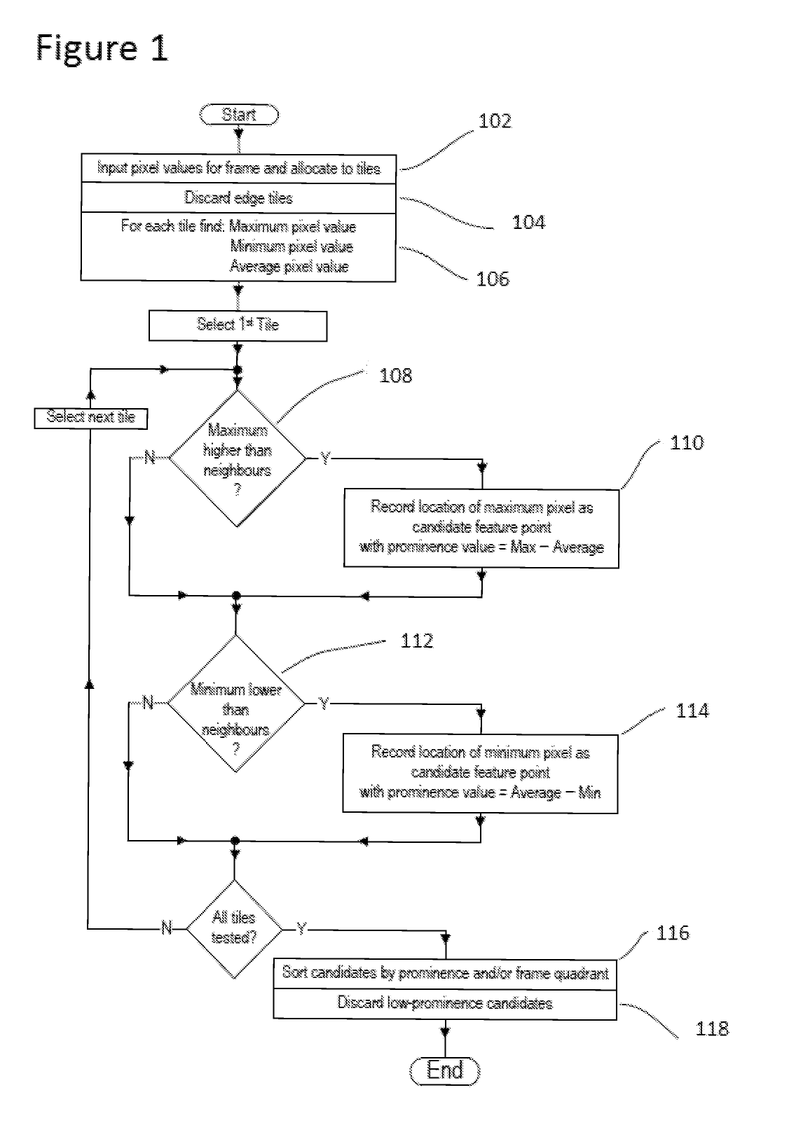

One method of characterising an image is to use feature points from the image. A flow-diagram of an exemplary process for determining a set of feature points for an image according to an embodiment of the invention is shown in FIG. 1. Pixel values are input to the process, possibly after going through a low pass filtering stage, typically they will be presented in the order corresponding to a scanning raster, with horizontal timing references interposed to indicate the left and right edges of the active image area. The image is divided into non-overlapping tiles and, in step 102, each incoming pixel value is associated with the tile of which it forms part.

In step 106 the pixel values of each tile are evaluated to find: the maximum-value pixel; the minimum-value pixel; and, the average pixel value for the tile. These values are then analysed to determine a set of candidate feature points. This can be done in a variety of ways and what follows is one example.

In step 108 the maximum value from the first tile is tested to see if it is higher than the maxima in the respective adjacent tiles. The edge tiles are excluded from this step as they do not have tiles adjacent to all of their sides. If it is, the process moves to step 110, in which the location of the respective maximum in the tile under test is stored, together with its location, as a candidate feature point. A ‘prominence’ parameter, indicative of the visual significance of the candidate feature point is also stored. A suitable prominence parameter is the difference between the value of the maximum pixel and the average value of all the pixels in its tile.

In step 112 the pixel values of the tile are evaluated to find the respective minimum-value pixel for the tile, and if the minimum is lower than the minimum value for the adjacent tiles, the process moves to step 114 where the respective minimum value in the tile under test is stored, together with its location, as a candidate feature point. An associated prominence value, equal to the difference between the value of the minimum pixel and the average value of all the pixels in its tile is also stored.

Once all non-image-edge tiles have been tested, the candidate feature points recorded in steps 110 and 114 are sorted according to their prominence values; and candidates with low prominence are discarded to reduce the number of feature point to a required number—say 36 feature point for the image.

It is also helpful to sort the candidate feature points within defined regions within the image. For example the image can be divided in four quadrants and the candidates in each quadrant sorted separately. A minimum and a maximum number of feature points per quadrant can be set, subject to achieving the required total number of feature points for the image. For example, if the candidates for a particular quadrant all have very low prominence, the two highest prominence candidates can be selected and additional lower prominence candidates selected in one or more other quadrants so as to achieve the required total number. This process is illustrated at step 118. Once the required number of feature points have been identified, the process ends.

An image of data can thus be characterised by a set of feature point data where the data set comprises at least the position of each feature point within the image and whether the feature point is a maximum value pixel or a minimum value pixel. In television images the positions of the feature points can be expressed as Cartesian co-ordinates in the form of scan-line numbers, counting from the top of the image, and position along the line, expressed as a count of samples from the start of the line. If the image has fewer or more than two dimensions then the positions of the feature points will be defined with fewer or more co-ordinates. For example feature points characterising a single-channel audio stream would comprise a count of audio samples from the start of the image and a maximum/minimum identifier.

It is an advantage that each determination of an interest point depends only on the values of the pixels from a small part of the image (i.e. the tile being evaluated and its contiguous neighbours). This means that it is not essential to have all the pixels of the image simultaneously accessible in the feature point identification process, with consequent reduction in the need for data storage.

The identification of a feature point is not heavily dependent upon the luminescence or contrast of an image, and therefore the use of feature points to match similar versions of the same content may be advantageous. However, one issue is that different screen ratios may lead to some feature points being removed from some versions of the content. It is also possible that in different resolutions the relative position of a feature point will shift slightly, or the point may be completely removed as the image is better resolved. Therefore a method is needed of characterising an image using identified feature points, but that mitigates against the disadvantages that they also present.

One way to do this is to form hashes from the feature points. For example, for each of the identified images a number of neighbouring feature points to the selected feature point can be identified. These may be the closest feature points in the image to the selected feature point, or they may be feature points that are within a specified area, or the most prominent feature points may be used. Once identified, these neighbouring feature points can be grouped into pairs. Each of these pairs can be used to form an individual hash. The series of hashes from each point can be used to characterise the image.

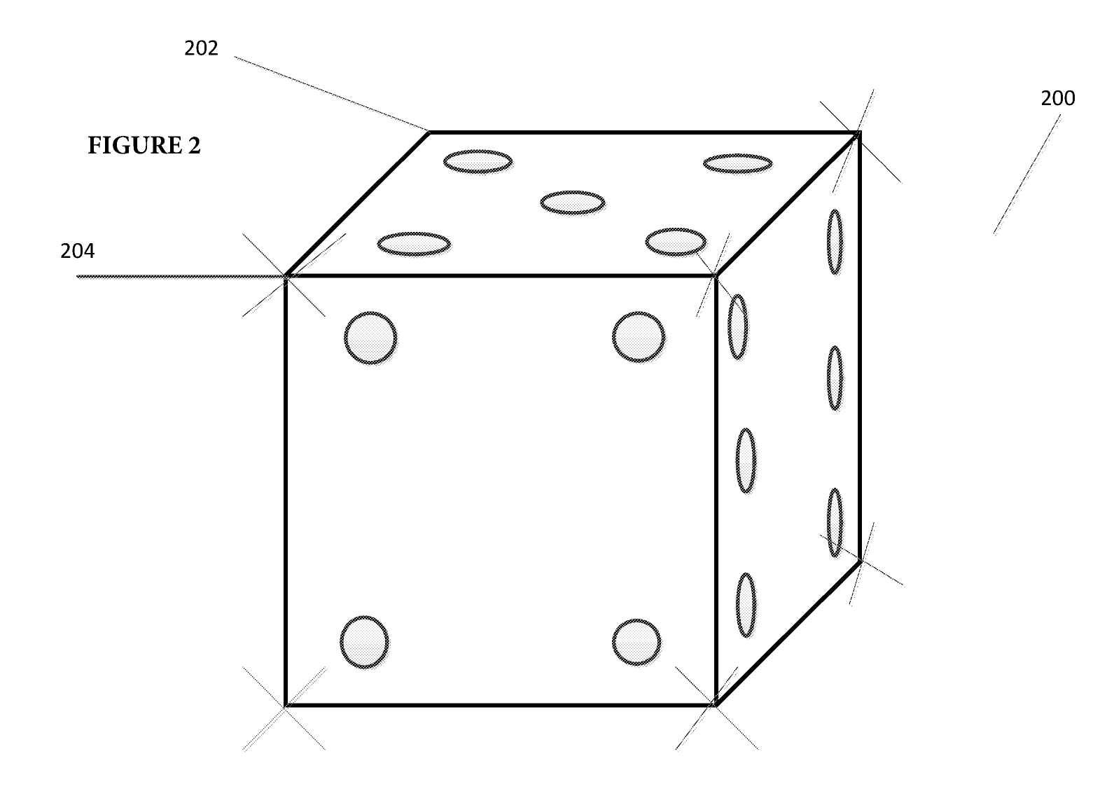

An example of an image which has had feature points identified is shown in FIG. 2. This shows an image 200 of a dice 202. Six feature points 204 have already been identified on the dice (these feature points have been selected for illustration purposes only). This shows how the feature points can be spread over an image, and how they can be used to characterise the image.

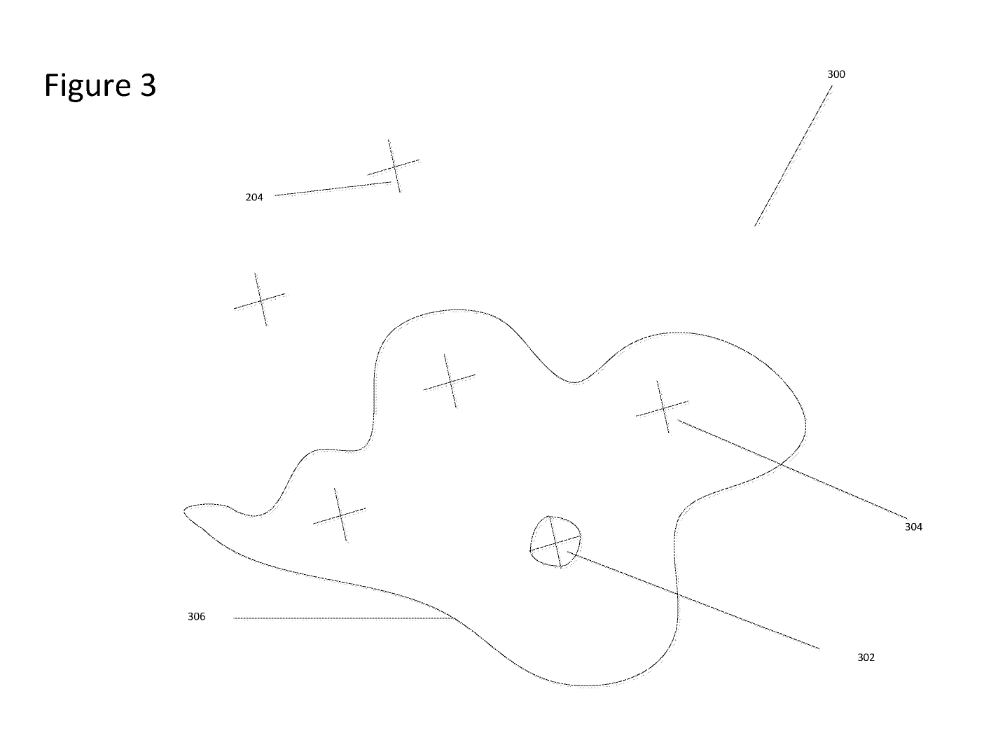

FIG. 3 shows the extracted feature points. Feature point 302 has been selected to be the selected feature point. Any number of neighbouring feature points can be identified; however in this example three such points 304 have been identified. In order to show these clearly box 306 has been drawn around the selected feature point 302 and the neighbouring feature points 304. The other feature points 204 have not been selected.

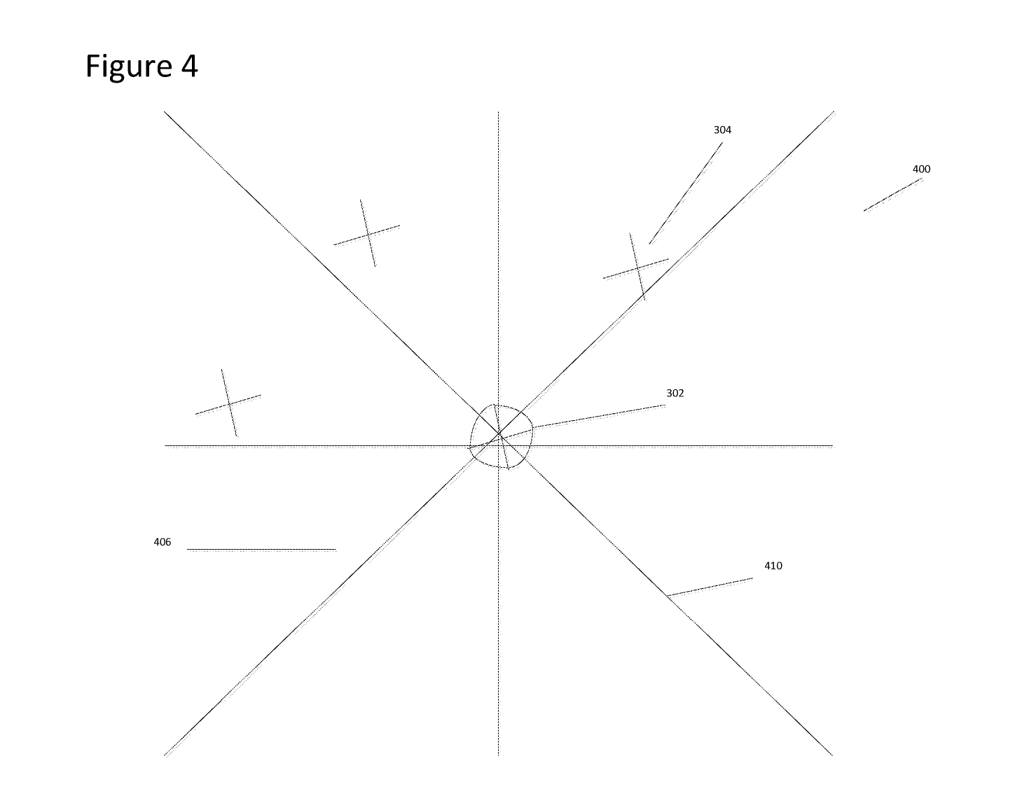

FIG. 4 is an image 400 showing the selected feature point 302 and the neighbouring feature points 304. The selected feature point is at the centre of the image and the image has been dissected by four lines dividing the image into eight equally sized regions 406. Any number of regions could be used, and the regions do not have to be the same size as one another. The regions form a set of relative locations that the neighbouring feature points can be located in, with each region being a relative location.

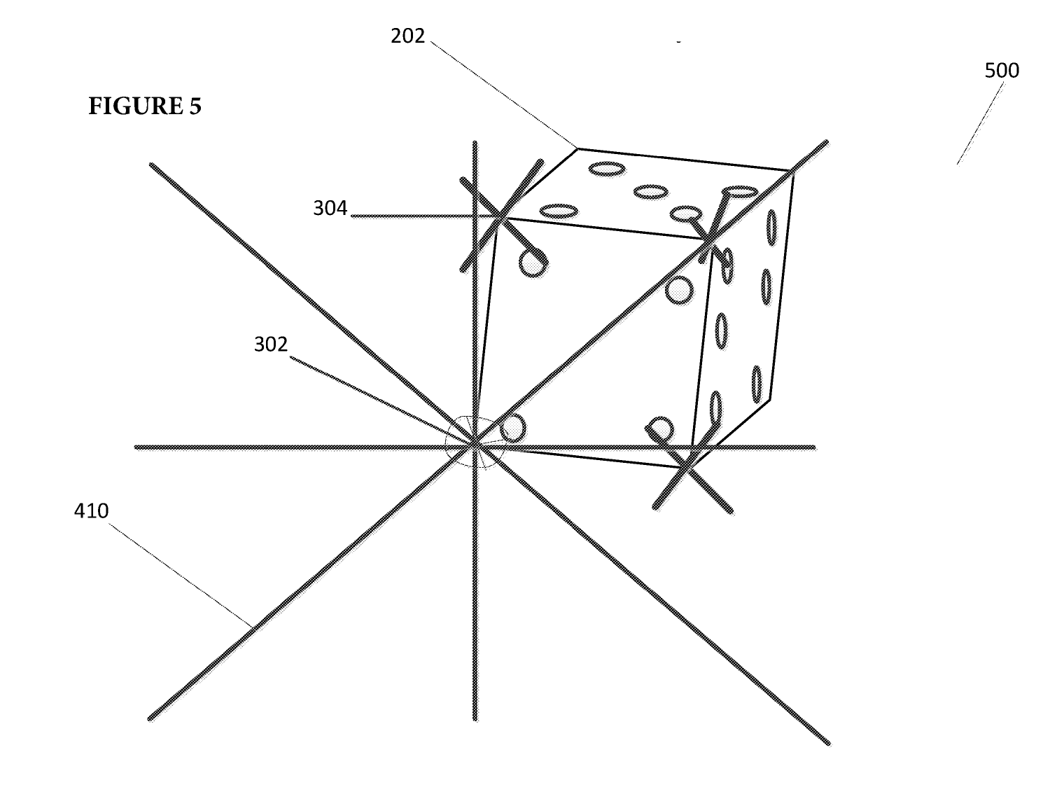

FIG. 5 shows an image 500, of the dice 202, the selected feature point 302, the neighbouring feature points 304 and the dissecting lines 410. This shows that each of the relative locations are not equal in absolute size. The dissecting lines would continue to the edge of the image. Instead the relative locations have an equally large angle between them.

Each hash includes information regarding the relative position of each of the neighbouring feature points to the selected feature point. These relative positions may be quantised into two or more regions. For example if eight regions are selected then the angles around the selected feature point may be split into eight equally sized portions. The neighbouring feature points will each be located in one of these regions and a hash that includes two neighbouring feature points will reflect which relative regions they are located in.

Other information about the neighbouring feature points and the selected feature point may be included in the hash. Making the hash more specific in this way will tend to reduce the number of false positives. Such additional information may include if the feature points are maxima or minima, or if the feature points are in parts of the image that have an orientation that is generally vertical or horizontal. The determination of the orientation may identify a dominant gradient. In one example the orientation is based on comparing the maxima with values of pixels a pre-set number of pixels away both horizontally and vertically. The orientation may be determined by calculating the absolute difference between these pixels and the maxima or minima vertically above and then adding the absolute difference between the maxima or minima vertically below. This is then repeated for the horizontal directions and then the orientation is determined to either be horizontal or vertical. Which half of the image the selected feature point resides in may also be of interest, along with the prominence that the feature points have against their local area in the image. This can be determined—for example—from the absolute difference between the maxima (or minima) and the average of the tile from which it comes.

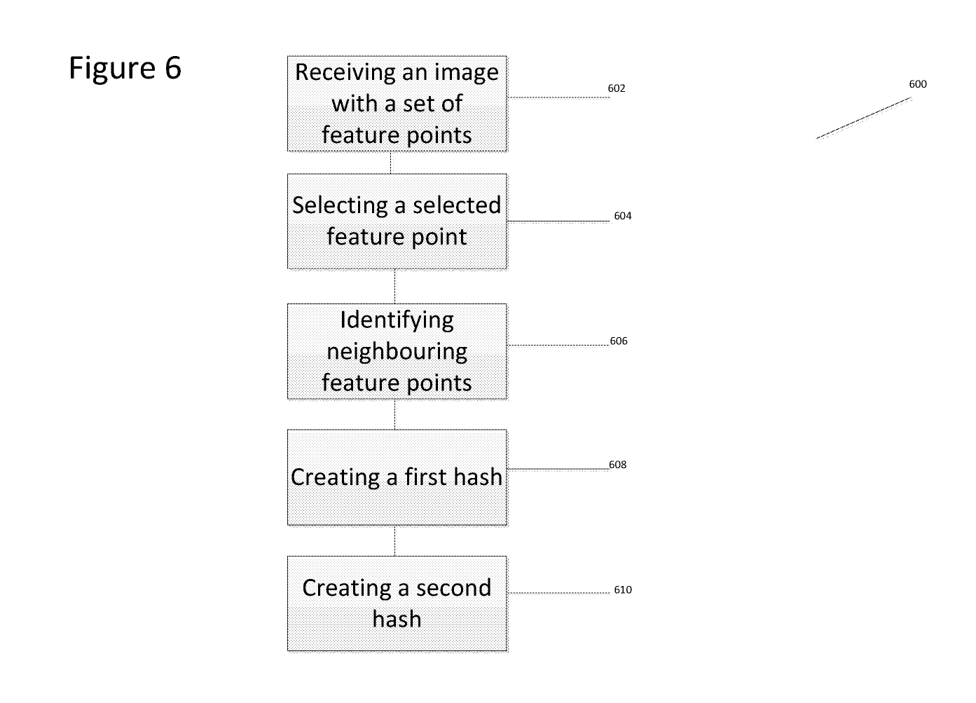

FIG. 6 shows a method 600 used to create the hashes. The first step 602 comprises receiving an image with a set of feature points. These feature points characterise the image and allow it to be identified. These may have been identified using any method, however it may be advantageous to have identified them in the manner described above. The next step 604 is to select a feature point. All of the feature points may be selected in turn, although some may be unused. After this the neighbouring feature points to the selected feature point are identified 606. These can be chosen according to a number of criteria, for example, they can be the closest feature points in the image by way of having the shortest distance between them, where distance is measured in any appropriate manner. Alternatively all of the feature points within a distance can be selected to be the neighbouring feature points. Other parameters can be used such as selecting points based on having a high prominence, or a prominence similar to the selected feature point.

Once these have been identified, according to whatever criteria, a first hash is created 608. To create the first hash a pair of neighbouring feature points are selected and the relative locations of these neighbouring feature points, relative to the selected feature point are measured, as shown in FIG. 4. The hash includes the information indicative of the relative locations. The smallest size the hash can be is two bits (if there is only one dissecting line and the relative location tells only which relative side of the selected feature point the neighbouring feature points are on). However it can be larger and preferably there are eight possible relative locations. Other features can be included in the hash. For example whether the selected feature point is maxima or minima, its orientation and prominence, and which half of the image it is in can all be included in the hash. These features can simply be shown by feature flags, which may be binary flags. The same information about the neighbouring feature points could also be included.

The next step is creating a second hash 610. To do so another pair of neighbouring feature points are selected and the relative locations of these neighbouring feature points are measured, relative to the selected feature point. The second pair can include one of the neighbouring feature points from the first pair, or it can be formed from two different neighbouring feature points. The second hash is then created in the same way as the first.

One embodiment of the hash creation may include identifying three, or potentially more, neighbouring feature points. If three neighbouring feature points are identified then only three pairs of them can be created. If 9 points are selected in each quadrant of the image, as may be advantageous in the feature point identification, then a large number of hashes will be created in order to characterise every image. This may be a large enough amount of hashes to ensure that, unless the hashes lack any real detail, random matches will be few.

In an embodiment, eight possible relative locations can be used for both the first and the second neighbouring feature points. By using eight relative locations only three bits of information are required, but the information is still relatively specific. If too many possible relative locations are used, then different versions of the same content with different aspect ratios may have the neighbouring feature points falling into different relative locations. When selecting the number of possible locations it is important that the locations are not so generic that little information is provided, but not so specific that errors become likely.

In an example an image has 36 selected feature points, 9 for each quadrant of the image. For each of the selected feature points 3 neighbouring feature points may be identified. For one such selected feature point the neighbouring feature points identified may be points A, B and C. The relative positions between the points A, B and C and the selected feature point are then determined. These can be used to form hashes. The first hash may be comprised of the relative location of point A relative to the selected feature point, as well as the relative location of point B relative to the selected feature point. The second hash may be comprised of the relative location of point A relative to the selected feature point, as well as the relative location of point C relative to the selected feature point. A third hash could be created using the relative location of point B relative to the selected feature point, and the relative location of point C relative to the selected feature point. There may be additional information in the hashes, in this example the hashes each contain a maxima/minima flag indicating whether the selected feature point is maxima or minima, an orientation flag indicating whether the selected feature point is orientated more horizontally or vertically, a flag to show which half of the image the selected feature point is in, a prominence order code for the selected feature point and the neighbouring feature points, as well as maxima/minima flags for the neighbouring feature points, and an orientation flag for each of the neighbouring feature points. The prominence order code indicates which of the selected feature point and neighbouring feature points is most prominent. It may also indicate which of the selected feature point and neighbouring points is next most prominent and least prominent. Each of the possible scenarios:
S,A,B
S,B,A
A,B,S
B,A,S
A,S,B
B,S,A
   (where the selected feature point is S and the neighbouring points are A and B) will have an associated prominence order code value.

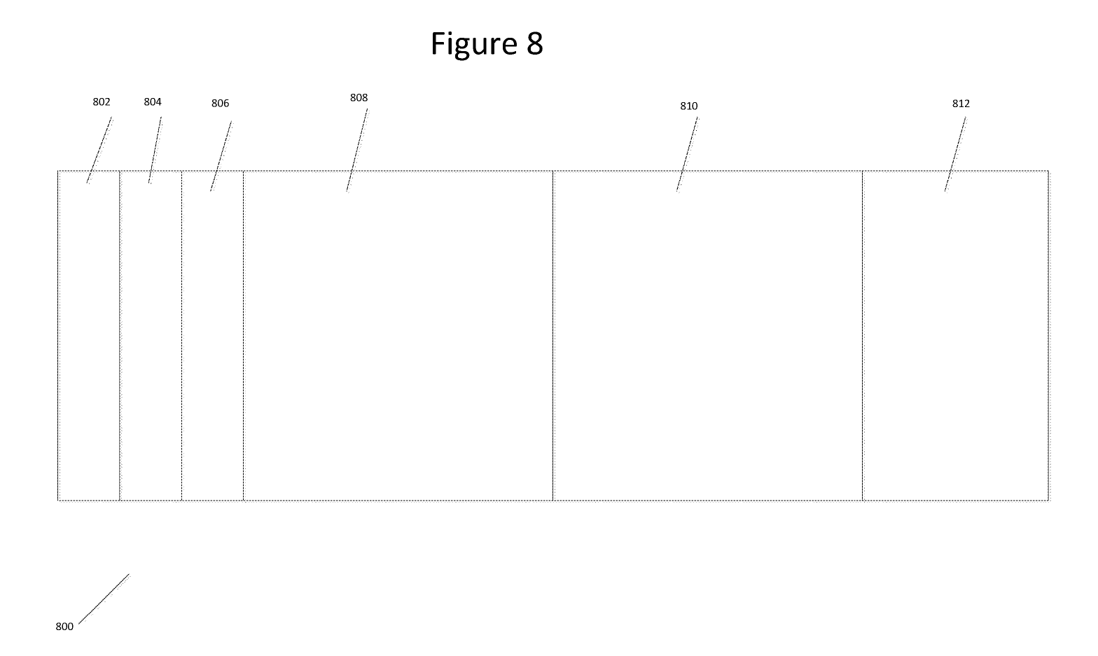

FIG. 8 shows an example of a possible hash structure 800 in line with the example discussed above. Section 802 of the hash may be associated with a maxima/minima flag for the selected feature point. Section 804 of the hash may be associated with an orientation flag for the selected feature point. Section 806 may be associated with which half of the image the selected feature point is located in. Section 808 may be associated with information associated with neighbouring feature point A. This includes a maxima/minima flag, an orientation flag, and location of point A relative to the selected feature point. Section 810 may be associated with information associated with feature B, and contain the same information as section 808, but associated with point B instead of point A. Section 812 may be associated with the prominence order code of the selected feature point and neighbouring feature points. In one example sections 802-806 may comprise 1 bit, sections 808 and 810 comprise 5 bits each, and section 812 may comprise 3 bits. In this example the hash would be 16 bits, or 2 bytes. In the example above 36 feature points were used to identify an image. If each of these had two associated hashes then there would be 72 hashes, and so 144 bytes of data to characterise the image. If there were three hashes per feature point this would rise to 216 bytes. This is a low amount of data compared to the information compared in a typical image.

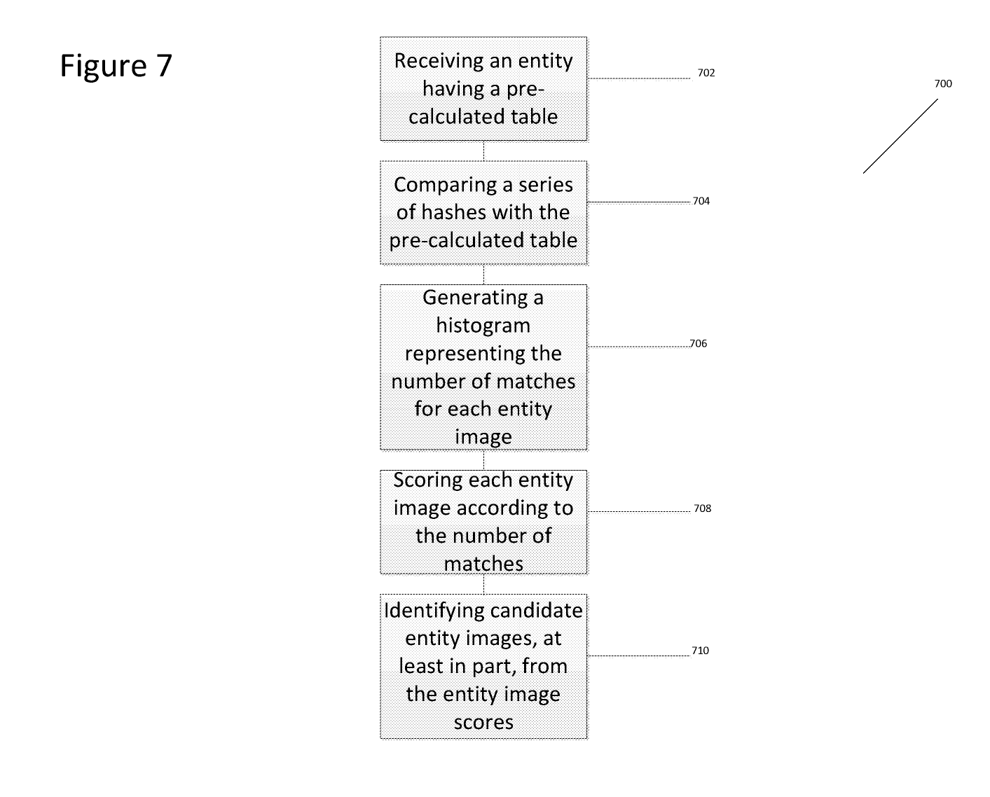

FIG. 7 illustrates a method 700 of identifying content in an entity. The first step comprises receiving an entity having a pre-calculated table. The pre-calculated table has a row for every possible hash value. Each of these rows are populated by entity image identifiers associated with entity images in which the hash occurs. The entity image identifier may be associated with the order in which the entity images are streamed when the entity is shown. For example, the first image in the entity may be numbered 1. Therefore a higher entity image identifier means that the image occurs later in the image sequence. If a hash occurs in a number of entity images (for example, the 34^{th}, 168^{th}, 3691^{st} and 46700^{th} entity images) then these entity image identifiers will be listed in the row for that hash. This means that the rows can be of different lengths, depending on how commonly they occur. The hashes for each of the entity images will have been calculated in the same way as is described above. Multiple hashes are therefore associated with each of a series of feature points characteristic of each entity image.

The next step comprises comparing a series of hashes (associated with one or more desired images) with the pre-calculated table 704. These hashes correspond to one or more desired images. The desired images may be temporally adjacent to one another, or they may not be. For example, the desired images may form a sequence of images that periodically skips one or more temporally adjacent images. A sequence of desired images could be images 1, 2, 3, 4, 5 and 6, or alternatively only images 1, 3 and 5, could be used. The hashes corresponding to the desired images are associated with each of a series of feature points characteristic of the one or more desired images.

The next step comprises generating a histogram representing the number of matches for each entity image 706. The histogram comprises a column for each entity image with at least one match. Additionally it may have a column for every entity image that does not have a match. This can be generated by taking the rows corresponding to the hashes that appear in the one or more desired images and adding a match every time an entity image identifier for a specific image is present.

In an another embodiment, more than one desired image may be used so that one most desired image can be matched more accurately. A most desired image is located in a sequence, if hashes associated with other images from this sequence are also matched with the pre-calculated table. A single histogram can be used collecting all of the data if the entity image identifiers are altered by adding a temporal offset to the matched entity images. If this set of desired images comprises images 4, 5 and 6, and 6 where image 6 is the most desired image, then when hashes associated with image 4 are matched with the pre-calculated table the entity image identifiers of the matching entity images may then be altered so that entity images that would match with hashes associated with desired image 6 can be found. For example, if the entity image identifiers are sequential then if hashes associated with desired image 4 match with entity images 78, 82 and 96 these can be altered by adding 2 to each of them. This means that entity images 80, 84 and 98 are added as matches to the histogram. This is then repeated for hashes associated with desired image 5, if these match with entity images 35, 83 and 107 then these can be altered by adding one to them. This means that entity images 36, 84 and 108 are added to the histogram. Hashes associated with desired image 6 are then matched and this returns results of entity images 9, 84 and 167 and these are added to the histogram. It seems clear from the collection of data that entity image 84 is the most likely match with the most desired image, although this wasn't clear from matching hashes associated with the most desired image 6 alone. The temporal offset applied to matches with hashes associated with desired images that are not the most desired image may be the same as the temporal difference between the matched desired image and the most desired image.

Each entity image is then scored according to the number of matches. This score may be the number of matches. Alternatively it may be a score out of a pre-set number so that, regardless of the number of hashes being compared, there is always a comparable result. This would normalise the score regardless of the number of hashes associated with the one or more desired images. It is possible that some hashes can be weighted more heavily than others. This may be because they are associated with a specific selected feature point. Such a point may be particularly central, or prominent and therefore be a more reliable indicator of a match.

Entity images may then be identified as possible candidate entity images. This may be at least in part due to the entity image score that was calculated. There may be a score threshold, wherein if a score for an entity image is above the score threshold then it is considered a candidate entity image. Alternatively other characteristics of an entity image may also be considered when identifying candidates.

Further steps may include designating the highest scoring entity image as being a matching image to the one or more desired images.

Alternatively the pre-set score threshold may be used to identify the candidates and then further steps may be taken to reduce the list. One problem with using a threshold is that in a video a lot of images within a temporal window are relatively similar. Therefore they will have a similar amount of hash matches. This means that the histogram will probably have broad large bumps, rather than sharp peaks, as a significant amount of images that are temporally close are all above a pre-set threshold. Therefore a further step may include ranking the entity images in order of the highest score measured and then deleting all of the images that are within a pre-selected temporal range from the list so that they are no longer considered candidate entity images. Then repeating this step by doing the same with the next highest entity image that is on the list until there are either no entity images left on the list or the bottom entity image on the list is reached. The entity images that were not deleted are then still considered candidate images. A further more extensive comparison test can then be used to find which entity image is a match. This may be performed by using a full fingerprint analysis technique.

When calculating an entity image score for each entity image each match may be weighted differently dependent upon a number of factors. For example, the desired image hash may be associated with a selected feature point. If the selected feature point is more prominent, or closer to the centre then the weighting of the match may be different. Additionally if one match is very common among the entity images this match may be weighted differently.

The pre-calculated tables are formed from recording the hashes that occur in each image in an entity. The hashes that occur in each entity are calculated in the same way as described above for a normal image.

Therefore, forming a pre-calculated table comprises creating a plurality of hashes for each of a set of images in an entity. Then creating the table comprises forming a table with a row for every hash value possible, recording in which entity images each hash occurs and populating each row of the table with entity image identifiers associated with entity images in which the hash occurs.

1-38. (canceled)

39. An image processing system for identifying an image in at least one video frame, the system comprising:
a feature point selector configured to select at least one feature point in an image having a set of feature points characteristic of the image;
a neighboring feature point identifier configured to identify a plurality of neighboring feature points associated with the selected feature point;
a hash generator configured to:
create a first hash comprising information associated with a first pair of neighboring feature points that includes first and second neighboring feature points of the identified plurality of neighboring feature points, wherein the information associated with the first and second neighboring feature points represents a location of the first pair of neighboring feature points relative to the selected feature point, and
create a second comprising information associated with a second pair of neighboring feature points that includes third and fourth neighboring feature points of the identified plurality of neighboring feature points, wherein the information associated with the third and fourth neighboring feature points represents a location of the second pair of neighboring feature points relative to the selected feature point; and
an image identifier configured to match the image with at least one matching image in an image database by comparing the first and second hashes with known hash values associated with the at least one matching image in the image database.

40. The image processing system of claim 39, wherein one of neighboring feature points of the second pair is a same feature point as one of the neighboring feature points of the first pair.

41. The image processing system of claim 39, wherein the information associated with each neighboring feature point comprises a value from a set of possible values, with each of the set of possible values represents a coarse relative location defined by a range of relative angles between the selected feature point and a neighboring feature point.

42. The image processing system of claim 39, wherein each of the first and second hashes comprises information associated with the selected feature point, including at least one selected feature point flag that identifies a half of the image where the feature point is located.

43. The image processing system of claim 39, wherein the feature point selector is further configured to select the at least one feature point in the image by splitting the image into a number of tiles, and identifying maximum and minimum points on each tile of the split image.

44. The image processing system of claim 43, wherein the feature point selector is further configured to:
group the selected at least one feature point points into four groups, wherein each group corresponds to the feature points contained within one quadrant of the image,
sort the plurality of feature points in each group in order of prominence, wherein prominence is determined from an absolute difference between a maxima or a minima, and an average of the respective tile,
select a number of most prominent feature points in each group as the selected feature points, while retaining a list of which feature points correspond to the minima and which to the maxima, and
combine the lists to form a list of selected feature points.

45. The image processing system of claim 39, wherein the image identifier is further configured to match the image by comparing the first and second hashes with a plurality of pre-calculated tables, each associated with an entity, wherein each pre-calculated table comprises a row for every possible hash value and each row is populated by image identifiers of images in the respective entity associated with a respective hash.

46. The image processing system of claim 45, wherein the image identifier is further configured to:
generate a histogram that represents matches between the first and second hashes and images in the respective entity, wherein the histogram comprises a column for each image of the entity with at least one hash match, and the column has a value that is equal to the number of hash matches, and
score each entity image according to the number of matches.

47. The image processing system of claim 46, wherein the image identifier is further configured to select the image having a highest score as the at least one matching image.

48. The image processing system of claim 46, wherein the image identifier is further configured to:
rank images with a score above a pre-set value in a list in order of score,
select a highest ranking image and delete all images within a pre-selected temporal range from the list,
repeat a ranking and selecting with a next highest remaining image until a lowest remaining image is reached or no lower image is available, and
further analyze the remaining images to determine a best match as the at least one matching image.

49. The image processing system of claim 46, wherein the image identifier is further configured to score each entity image by a weighting value depending upon matching hashes.

50. The image processing system of claim 46, wherein the weighting value is dependent on at least one of a closeness of the selected at least one feature point to a center of the image, a prominence of the selected at least one feature point, and a number of entity images that are matched to the first and second hashes.

51. An image processing system for identifying an image in at least one video frame, the system comprising:
an electronic memory configured to store a pre-calculated table associated with an entity that comprises a plurality of entity images, wherein the pre-calculated table includes a plurality of rows for hash values associated with the entity images and each row is populated by a respective entity image identifier for a respective entity image associated with a respective hash value, and wherein the hash values are associated with a series of feature points characteristic of each entity image;
a hash value comparator configured to compare a series of hashes representing one or more desired images with the pre-calculated table, with the series of hashes being associated with each of a series of feature points characteristic of the one or more desired images;
a histogram generator configured to generate a histogram that represents a number of matches between the series of hashes and each entity image, with the generated histogram comprising a column for each entity image with at least one hash match;
an entity image scorer configured to score each entity image based on the number of matches; and
an image identifier configured to identify candidate entity images based on the scored entity images.

52. The image processing system of claim 51, wherein the image identifier is further configured to select a matching image as the candidate entity image with a highest score.

53. The image processing system of claim 51, wherein the image identifier is further configured to:
rank entity images with a score above a pre-set value in a list in order of score,
select a highest ranking entity image and delete all images within a pre-selected temporal range from the list,
repeat a ranking and selecting with a next highest remaining image until a lowest remaining image is reached or no lower entity image is available, and
further analyze the remaining images to determine a best match as a matching image.

54. The image processing system of claim 51, further comprising:
an entity partitioner configured to partition the entity into two or more segments if the number of matches exceeds a pre-set limit,
wherein the histogram generator is configured to generate a histogram for each of the two or more segments.

55. The image processing system of claim 51, wherein the hash value comparator is further configured to sequentially compare the series of hashes with the pre-calculated table, such that all the hashes associated with a first desired image are compared before the hashes associated with a next desired image are compared.

56. The image processing system of claim 55, wherein the histogram generator is configured to add an temporal offset to the entity image matches of hashes associated with desired images that are not a most desired image, wherein the temporal offset is a same as the temporal offset between the matched desired image and the most desired image.

57. The image processing system of claim 51, further comprising a hash generator configured to generate the series of hashes representing the one or more desired images by:
identifying a number of feature points in a desired image that characterize the desired image;
identifying, for each feature point, three nearest neighboring feature points; and
generating three hashes for each of the identified feature points, wherein each created hash is comprised of features of two of three neighboring points.

58. The image processing system of claim 57, wherein the hash generator is configured to generate the three hashes for each feature point by:
creating a first hash comprising information associated with a first closest neighboring feature point and a second closest neighboring feature point, wherein the information associated with the first and second closest neighboring feature points represents a location of the first and second closes neighboring feature points relative to the selected feature point;
creating a second hash comprising information associated with the first closest neighboring feature point and a third closest neighboring feature point, wherein the information associated with the first and third closest neighboring feature points represents a location of the first and third closest neighboring feature points relative to the selected feature point;
creating a third hash comprising information associated with the second closest neighboring feature point and the third closest neighboring feature point, wherein the information associated with the second and third neighboring feature points represents the location of the second and third neighboring feature points relative to the selected feature point.
